(19) United States
(12) Patent Application Publication
(10) Pub. No.: US 2006/0062904 A1
(43) Pub. Date: Mar. 23, 2006

(54) Long cycle life elevated temperature thin film batteries

(76) Inventors: William C. West, Pasadena, CA (US); Jay F. Whitacre, South Pasadena, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/187,560

(22) Filed: Jul. 22, 2005

Related U.S. Application Data
(60) Provisional application No. 60/590,726, filed on Jul. 23, 2004.

(51) Int. Cl. B05D 5/12; H01M 10/04

(52) U.S. Cl. 427/126.3; 29/623.5; 29/623.2

(57) ABSTRACT

A method of preparing a cathode electrode suitable for use in a thin film battery that includes applying an adhesion layer on a substrate; forming a current collector layer on the adhesion layer; and forming a layer of a Group 6 oxide composition on the current collector layer, wherein the Group 6 oxide composition consists essentially of MoO₃ or WO₃.

### RELATED APPLICATIONS

This application claims benefit of priority from U.S. Provisional Application Ser. No. 60/590,726, filed Jul. 23, 2004, which is hereby incorporated by reference.

### STATEMENT OF ACKNOWLEDGMENT OF GOVERNMENT SUPPORT

The invention described herein was made in the performance of work under a NASA contract, and is subject to the provisions of Public Law 96-517 (35 U.S.C. § 202) in which the Contractor has elected to retain title.

### BACKGROUND

Lithium (Li) thin film battery cells are the currently preferred battery materials because they offer outstanding cycle life times and long term shelf life. One of the important advantages that Li thin film battery cells offer beyond these attributes is the robustness inherent in the solid-state design; that is, the ability to tolerate temperature extremes, mechanical shock, vibration and moderate flexture far better than conventional Li-ion or Li polymer cells. For example, cells with Li anodes plated in situ can be exposed to solder reflow temperatures of up to 250° C. for ten minutes without any degradation in performance. This remarkable robustness is particularly important for aerospace applications, wherein battery performance must meet long term power demands in critical circuits under elevated temperatures. For example, the application of thin film battery cells used in a power system externally mounted on a LEO spacecraft, the cells will likely be exposed to temperatures of about 120° C.

However, an inherent limitation of state-of-art Li thin film batteries is their sensitivity to deterioration when the cells are cycled at elevated temperatures. Cells incorporating LiCoO₂ cathodes, which currently represent the most widely employed cathode for this type of battery, can be charged and discharged at 25° C. over tens of thousands of cycles and experience capacity losses of only about 0.002% per cycle. In contrast, LiCoO₂ based cells that are operated at 60° C. experience a factor of ten greater capacity loss per cycle. Recent laboratory experimentation has resulted in the discovery that the capacity fade per cycle is even more severe at even higher temperatures, wherein the extant cells display marked capacity fade to 50% of initial values after only 100 cycles when these cells are operated at temperatures of 150° C.

In order to develop thin film battery cells with excellent cyclability at elevated temperature, it is imperative to understand the failure mechanisms for these devices. Wang et al. measured increases in cell resistance of LiCoO₂ thin film battery cells with cycling, which was exacerbated when cycling at elevated temperatures. This resistance was attributed to strain-induced structural changes in the cathode layer that reduced Li⁺ ion mobility. Dudney et al. found that thin film battery cells with nano-crystalline LiₓMn_{2-y}O₄ cathodes experienced modest increases in resistance with cycling at room temperature, resulting in lower practical capacity due to polarization losses. When these cells were cycled at 100° C., the capacity fade was much greater, though the authors note the aging mechanisms proceeded differently than at room temperature. Again, the exact nature of the physiochemical changes in cell structure with cycling at elevated temperature was not clear, though deleterious phase transformations seem to have been indicated.

Alternative thin film cathodes were investigated to identify materials that could better tolerate microstructural and phase change transformations with cycling. Molybdenum trioxide (MoO₃) is an attractive candidate from several standpoints. The thermodynamically favored orthorhombic α-MoO₃ can reversibly insert via a topotactic reaction up to 1.5 Li atoms per MoO₃ molecule, corresponding to a specific capacity of 279 mAh/g and a discharge cutoff voltage of 1.5V vs. Li/Li⁺. Assuming fully densified films, this would equate to a specific capacity of 131 μAh/(cm²-μm), as compared with 69 μAh/(cm²-μm) for LiCoO₂. Its polymorph, β-MoO₃ has been shown to intercalate up to 2 Li atoms per MoO₃. It is known that MoO₃ upon the first lithiation and subsequent delithiation undergoes significant irreversible microstructural changes such as fracture and disintegration of the grains. However, lithium reversibility in MoO₃ appears to be quite insensitive to these crystallographic and morphological changes, provided the cathode material remains intact on the electrode.

The invention disclosed herein addresses the need to improve Li thin film battery performance in the area of long cycle life when the batteries are operated 10 under elevated temperature conditions. The object of the invention disclosed herein addresses the feasibility of improving Li thin film battery cell performance in this area by development of a cathode composition comprising MoO₃ or Tungsten trioxide (WO₃). In contrast to Li thin film battery cells containing LiCoO₂ cathodes, Li thin film battery cells containing the new cathode compositions display markedly improved long cycle life without significant fade in their specific capacity when the cells are evaluated under high temperature conditions.

### SUMMARY

In a first aspect, the present invention is a method of preparing a cathode electrode suitable for use in a thin film battery that includes applying an adhesion layer on a substrate; forming a current collector layer on the adhesion layer; and forming a layer of a Group 6 oxide composition on the current collector layer. The Group 6 oxide composition for instance consists essentially of MoO₃ or WO₃.

In a second aspect, the present invention is a method of preparing a thin film battery cell that include applying an adhesion layer on a substrate; forming a current collector layer on the adhesion layer; applying a first shadow mask of a first defined area on the current collector layer to provide a shadow masked current collector area; forming a layer of a group 6 oxide on the shadow masked current collector area to provide a cathode electrode layer; forming a solid electrolyte film layer comprising LiₐP_{b}O_{c}N_{d} on the cathode electrode layer; applying a second shadow mask of a second defined area on the solid electrolyte film layer to provide a shadow masked solid electrolyte film layer; forming a metal anode layer on the shadow masked solid electrolyte film layer to complete the thin film battery cell; and sealing the thin film battery cell with a suitable sealant. The symbol a comprises a value from about 3 to about 3.3, the symbol b comprises a value of about 1, the symbol c comprises a value from about 3 to about 4, and the symbol d comprises a value from about 0.1 to about 0.3. The second defined area is coincident with or a subset of the first defined area.

In a third aspect, the present invention is a cathode electrode suitable for use in a thin film battery cell that includes a substrate; an adhesion layer applied on the substrate; a current collector layer formed on the adhesion layer; and a cathode layer comprising a group 6 metal oxide formed on the current collector layer. The resultant cathode electrode displays a specific capacity in the range from about 190 mAh/g to about 300 mAh/g or a specific capacity from about 90 μAh/(cm²-μm) to about 140 μAh/(cm²-μm).

In a fourth aspect, the present invention is a thin film battery cell that includes a substrate; an adhesion layer applied on the substrate; a current collector layer formed on the adhesion layer; a cathode layer comprising a group 6 metal oxide formed on the current collector layer; a solid electrolyte film layer composed of Li_{3.3}PO_{3.8}N_{0.22} formed on the cathode layer; a metal anode layer comprising Li deposed on the solid electrolyte layer to complete the thin film battery cell; and a sealant. The resultant thin film battery cell displays a performance attribute that includes (1) a specific capacity from about 90 μAh/(cm²-μm) to about 160 pAh/(cm²-μm) or (2) a specific capacity that does not appreciably deteriorate with cycling of the thin film battery cell at a temperature of greater than about 100° C.

### BRIEF DESCRIPTION OF THE DRAWINGS

FIG. 1A depicts a cut-away elevational perspective of a cathode composition fabricated according to the present invention, wherein the cathode 100 includes a base support substrate 101, an adhesion layer 102, a current collector layer 103, a shadow masked area 104, and a cathode layer 105;

FIG. 1B depicts a top view of cathode 100, wherein the cathode layer 105 contacts the current collector layer 103 via the boundary of the shadow masked area 104, shown here, for example, as a regular rectangular area;

FIG. 1C depicts a cut-away elevational perspective of a complete Li thin film battery cell 200 fabricated according to the present invention, wherein the battery cell 200 includes a base support substrate 201, an adhesion layer 202, a current collector layer 203, a first shadow masked area 204, a cathode layer 205; a solid electrolyte layer 206, a second shadow masked area 207, an anode layer 208, and a sealant 209;

FIG. 1D depicts a top view of the Li thin film battery 200, wherein the anode layer 208 is in electrical communication with the cathode layer 205 via a solid electrolyte layer 206, as defined via the boundary of the second shadow masked area 207, shown here, for example, as a regular rectangular area;

FIG. 2A depicts scanning electron microscopy micrographs of MoO₃ thin films as deposited (50,000× magnification);

FIG. 2B depicts scanning electron microscopy micrographs of MoO₃ thin films after annealing at 280° C. for 1 hour (500× magnification);

FIG. 2C depicts scanning electron microscopy micrographs of MoO₃ thin films after annealing at 280° C. for 1 hour (50,000× magnification);

FIG. 3 depicts XRD diffraction patterns for (A) MoO₃ films on Pt current collectors on Si substrates after annealing at 280° C. for 1 hour and (B) for MoO₃ films on Pt current collectors on Si substrates as deposited; Discharge curves as a function of cycle number at 150° C. at discharge current density of 0.7 mA/cm²;

FIG. 4 depicts discharge curves as a function of cycle number at 150° C. at discharge current density of 0.7 mA/cm²;

FIG. 5 depicts typical charge/discharge profile of MoO₃ at 150° C., current density of 0.7 mA/cm²;

FIG. 6 depicts a comparison of energy density for LiCoO₂ and MoO₃ cathodes at 150° C. at discharge current density of 0.7 mA/cm²;

FIG. 7 depicts the discharge rate capability for MoO₃ at 150° C., taken at charge/discharge cycle number 1743;

FIG. 8 depicts results of an experiment using Potentiostatic Intermittent Titration Technique (PITT) illustrating a chemical diffusion coefficient of 7.5×10⁻¹¹ cm²/s at 153° C. at 2.24V; the inset shows the current versus time raw data; and

FIG. 9 depicts the cycle life of thin film batteries at 150° C. with LiCoO₂ and MoO₃ cathodes, wherein the discharge current density is 0.7 mA/cm².

### DETAILED DESCRIPTION

The present invention makes use of the discovery of solid-state Li thin film cells using MoO₃ and WO₃ cathodes that have superior cycle life and specific capacity compared with state-of-art LiCoO₂ based Li thin film cells. At 150° C., the MoO₃ cells could be cycled at deep charge and discharge voltages over thousands of cycles with no apparent long term capacity fade, in contrast to LiCoO₂ cells which experienced severe capacity fade over a few hundred cycles at this temperature. The practical specific capacity of the MoO₃ cathodes, approximately 140 μAh/(cm²-μm), is about twice that of state-of-art LiCoO₂ cells. The rate capability of the MoO₃ cells at 150° C. is very good, with cells experiencing little polarization at rates of about 1 mA/cm². Thin film cells containing these novel cathode compositions will be of interest for use in elevated temperature applications. The fabrication process for preparing these novel cathode compositions and their suitability in thin film battery cells are described below.

Cathode Compositions, Fabrication, and Attributes

The present invention is directed to cathode compositions of oxides of metals from group 6 of the Periodic Table, including Chromium (Cr), Molybdenum (Mo), Tungsten (W), and Seaborgium (Sg). More preferably, the cathode compositions consist essentially of Mo oxides or W oxides. Most preferably, the cathode compositions consist essentially of Mo oxides. The preferred valency of group 6 metal oxides is MOₙ, where M represents a metal from group 6 of the Periodic Table, 0 represents oxygen, and the value of n is in the range from about 2.7 to about 3.3, including 2.7, 2.8, 2.9, 3.0, 3.1, 3.2, and 3.3. Preferred cathode compositions include MoO₃ and WO₃.

Preferred cathode compositions need not be pure group 6 metal oxides for achieving the performance characteristics of the present invention. Mixed metal oxide compositions, such as MoO₃/WO₃ mixtures, wherein one or more group 6 metals are present in the cathode layer are feasible. Further, mixtures of metal oxides of mixed valency, such as MO_{2.7}/MO_{3.3} mixtures, may be present in the cathode layer without substantially compromising cathode electronic performance. Finally, cathode layers containing small amounts of contaminants such as non-group 6 elements or non-metal oxides, are tolerated. As elaborated below, non-group 6 metal oxide compositions may arise from small impurities being present during the sputtering process, such as that which may be associated a contaminated sputter target. Without being limited to any particular theory, the preferred cathode compositions of the present invention may contain other materials or contaminants to the extent that these materials do not interfere with the processes of Li⁺ ion intercalation and deintercalation occurring within individual metal oxide layers as Li⁺ ions move between metal oxide layers within the cathode composition when cells containing such cathode compositions are cycled at high temperatures.

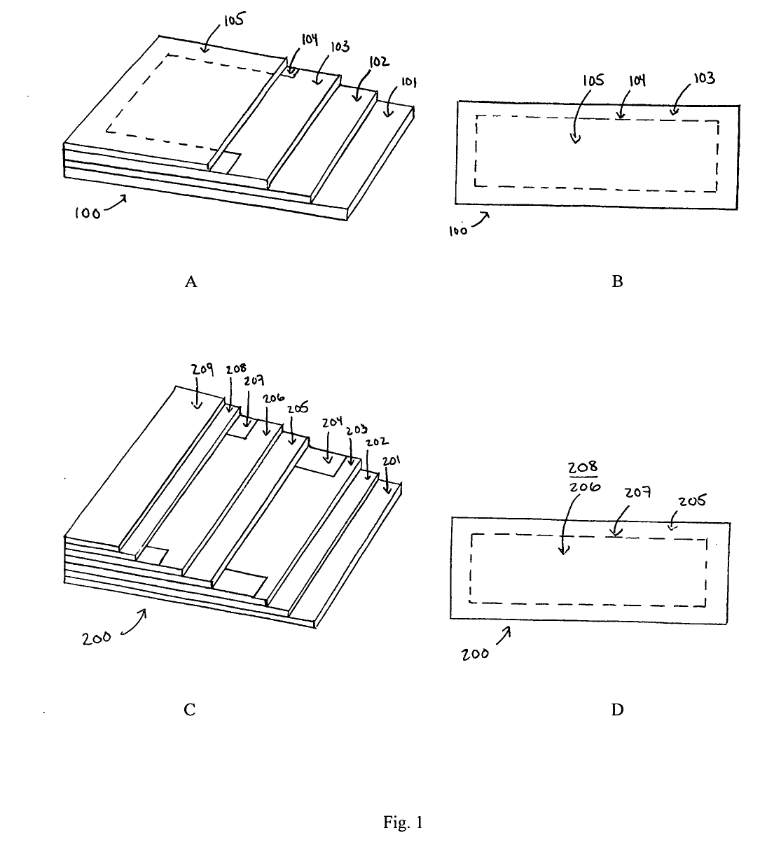

As illustrated in FIGS. 1A and 1B, the preferred fabrication of the cathode 100 is to apply an adhesion layer 102 on a substrate 101, to form a collector layer 103 on the adhesion layer 102, to form a shadow masked area 104 on the collector layer 103, and to form the cathode electrode layer 105 on the shadow-masked collector layer 103. The individual layers are preferably formed using sputtering techniques. Each of these materials and processes are described below.

The cathode 100 is prepared on a substrate 101 composed of thin materials, such as thin non-metallic/non-polymer substrates, thin metal foils, and polymer materials. Thin materials are preferred because one object of the present invention is the fabrication of thin battery cells having a high specific capacity. This performance attribute is achieved by using thin substrate materials that contribute nominally to the overall weight of the battery cell. Examples of thin non-metallic/non-polymer substrates include silica, mica, silicate Fe—K compositions, silicon (Si) substrates, and Si₃N₄-coated Si substrates. Examples of thin metal foils include foils composed of titanium (Ti), gold (Au), and Aluminum (Al), among others. Examples of polymer materials would be any polyimide composition having high heat resistance, such as Kapton. For the purposes of preparing different cathode compositions for performance evaluation or experimental work, thin silica substrates are preferred substrates owing to the convenience, economic cost, and availability of these materials. Commercial substrates composed of thin metal foils having a material composition other than a precious metal, such as Au, are preferred, owing to the economic cost of such materials.

All film layers are preferably formed in cathode 100 by using a sputter deposition technique. Sputter deposition is performed on substrates in a planar RF magnetron sputtering chamber, evacuated to a base pressure of less than 5×10⁻⁶ Torr with a turbomolecular pumping system. Sputter deposition techniques are well known in the art, such as those disclosed in “A LOW Pt CONTENT DIRECT METHANOL FUEL CELL ANODE CATALYST: NANOPHASE PtRuNiZr” by Sekharipuram R. Narayanan, Ph.D. and Jay F. Whitacre, Ph.D., U.S. patent application Ser. No. 11/060,629, filed Feb. 17, 2005, the entire contents of which are hereby incorporated by reference. The advantage of using sputtering in the present invention is the degree of flexibility the technique affords one for forming material compositions of defined stoichiometry within the resultant deposition layers.

Referring to FIG. 1A, the adhesion layer 102 is applied to the substrate 101 by sputter deposition. Preferred adhesion layer material compositions include metal oxides that are formed from metals belonging to the groups 4, 6, and 9 of the Periodic Table, except for the noble metals within those groups. More preferably, adhesion layer material compositions include metal oxides formed from cobalt (Co), Mo, and titanium (Ti). Titanium oxide is the most preferred adhesion layer material composition.

Referring to FIG. 1A, the current collector layer 103 is applied on the adhesion layer 102 by sputter deposition. Preferred current collector material compositions include any chemical element that is substantially inert to anodic oxidation, which arises initially at the cathode when the voltage increases during charging. Examples of such current collector material compositions include platinum (Pt) and Mo. The preferred current collector material composition is Pt.

Referring to FIG. 1A, a shadow masked area 104 is formed on the current collector layer 103. The shadow masked area 104 can represent any closed dimensional area without regard to shape or size of the area of the current collector layer 103 so bounded. Shadow masking methods are well understood in the art, as disclosed by, for example, Narayanan and Whitacre (2005).

Referring to FIGS. 1A and 1B, the cathode layer 105 is formed on the shadow-masked current collector layer 103 by sputter deposition. As discussed above, preferred cathode layer material compositions include group 6 metal oxides; more preferred cathode layer material compositions include MoOₙ and WOₙ, wherein the symbol n is a value in the range 2.7 to about 3.3, including values 2.7, 2.8, 2.9, 3.0, 3.1, 3.2, and 3.3; an even more preferred cathode layer material composition is MoO₃ or WO₃; and the most preferred cathode layer material composition is MoO₃. The metal:oxygen stoichiometry for the cathode layer, such as MoO₃, is established by forming the layer under a sputtering condition that is either oxygen poor or oxygen rich. When the sputtering process occurs in an argon (Ar) environment using a MoO₃ sputter target, MoOₙ layers are formed, wherein the symbol n is a value less than about 3. When the sputtering process occurs in an O₂ environment using a MoO₃ sputter target, MoOₙ layers are formed, wherein the symbol n is a value greater than about 3.

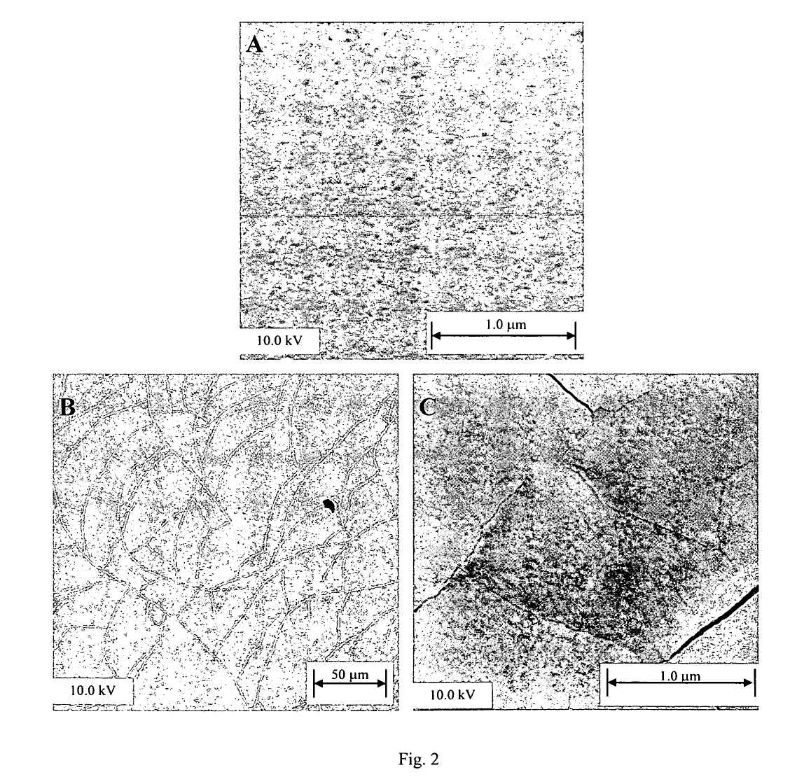

The sputtered films will typically vary in color, from transparent with a slight yellow to purple tint, and are generally featureless as shown in SEM micrographs (FIG. 2A). Upon annealing, the films become hazy due to the formation of numerous surface cracks (FIGS. 2B and 2C). The films, although fractured on annealing, remain intact and could be used as thin film battery cathodes without any special accommodations.

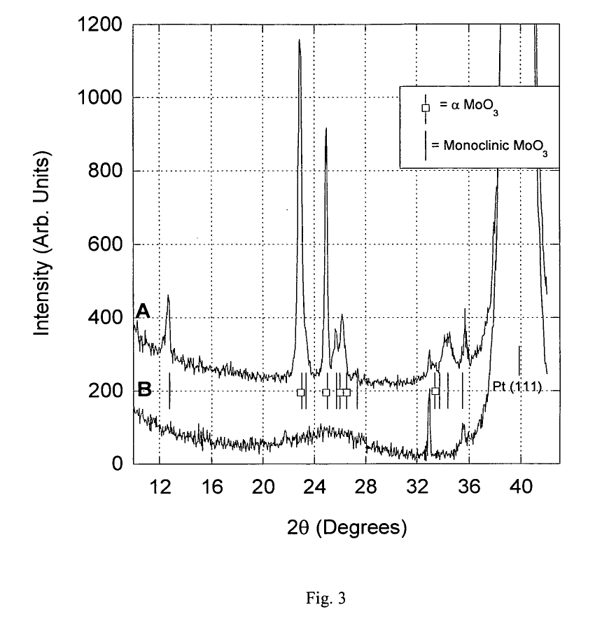

As deposited, the MoO₃ films are amorphous. Following an annealing step in a temperature range from about 280° C. to about 500° C. for one hour, the MoO₃ film crystallized as mixed phases of layered α-MoO₃ and monoclinic β-MoO₃ (FIG. 3). Sputtered thin films of MoO₃ are often mixed phase α-MoO₃ and β-MoO₃ following a brief anneal of about 300-500° C. If sputtered in an O₂-poor ambient, sub-stoichiometric MoOₓ (x<3) can also result, which appears to enhance electronic conductivity.

Li Thin Film Battery Cell Compositions, Fabrication, and Attributes

As illustrated in FIGS. 1C and 1D, the preferred fabrication of the Li thin battery cell 200 is to apply an adhesion layer 202 on a substrate 201, to form a collector layer 203 on the adhesion layer 202, to form a first shadow masked area 204 on the collector layer 203, to form the cathode electrode layer 205 on the shadow-masked collector layer 203, to form a solid electrolyte layer 206 on the cathode layer 205; to form a second shadow masked area 207 on the solid electrolyte layer 206; to form an anode layer 208 on the shadow-masked solid electrolyte layer 206, and to seal the battery cell 200 with a suitable sealant 209. The individual layers are preferably formed as films using the disclosed sputtering technique, although other techniques for applying the layers may be used successfully, unless otherwise disclosed. Many of these materials and processes are described below.

Referring to FIG. 1, the formation of the battery cell 200 through completion of the step of forming the cathode layer 205 is practiced in accordance with the formation of cathode 100 disclosed above, including use of the preferred materials and methods described therein.

Referring to FIG. 1C, a solid electrolyte layer 206 is formed on the cathode layer 205 using sputter deposition. Preferred solid electrolyte layer material compositions include LiₐP_{b}O_{c}N_{d} (hereinafter “LiPON”) wherein the symbol a comprises a value from about 3 to about 3.3, the symbol b comprises a value of about 1, the symbol c comprises a value from about 3 to about 4, and the symbol d comprises a value from about 0.1 to about 0.3. Though less preferred, sulfur (S) can substitute for oxygen or nitrogen of LiPON compositions. The preferred solid electrolyte layer material composition is Li_{3.3}PO_{3.8}NO_{0.22}. The desired LiPON compositions for the solid electrolyte layer 206 are formed on the cathode layer 205 by using a Li₃PO₄ sputtering target in a RF magnetron sputtering chamber in the presence of an electrically charged mixture of N₂ and Ar gases. Without being bound to any particular theory, the presence of these gases, as well as their particular stoichiometric ratios, in an electrically charged state results in compositional fragmentation of Li₃PO₄ and recombination of the resultant radicals with N₂ plasma products in the film layer formed on the substrate during the sputtering process.

Referring to FIGS. 1C and 1D, a second shadow masked area 207 is formed on the solid electrolyte layer 206. The first shadow masked area 204 and the second shadow masked area 207 are formed their respective substrates of battery cell 200 in a manner similar to, if not identical with, that disclosed for the shadow masked area 104 of cathode 100. Preferably, the second shadow mask area 207 is of a similar dimensional area as the first shadow mask area 204 such that both shadowed masked areas are substantially coincident. The dimensional unity and coincidence of first shadow masked area 204 and the second shadow mask area 207 is preferred because any areas of non-overlap between these shadow masks would not result in any electrical conductivity between the cathode layer 205 and the anode layer 208 of the battery cell 200.

Referring to FIG. 1C, an anode layer 208 is formed on the shadow-masked solid electrolyte layer 206. The preferred anode material compositions include elements from group I of the Periodic Table. Even more preferred anode material composition include Li and sodium (Na). The most preferred anode material composition is Li.

Sputtering depositions are disfavored for forming the Li anode layer because a Li sputtering target would melt during sputtering deposition, owing to the low melting temperature of Li. Thermal evaporation is preferred method to form a Li anode layer onto the shadow masked electrolyte layer. Thermal evaporation techniques for forming a Li anode layer are well known in the art, such as that exemplified by Bates et al. (1993).

Referring to FIGS. 1C and 1D, the battery cell 200 is sealed with a suitable sealant 209. The preferred sealant protects the anode layer 208 of battery cell 200 from moisture and oxygen. Suitable sealants include a protective foil covering, a polyimide composition, or any other sealants known in the art. A preferred sealant having a polyimide composition is Kapton tape. The most preferred sealant is a proprietary sealant produced by Front Edge Technologies.

If foil covering is selected as the protective sealant, it should be noted that the anode film layer should have the same elemental composition as the foil composition. For example, a Li foil, rather than a Na foil, should be used as a sealant for battery cell 200 having anode layer 208 composed of Li. This is due to fact that the elemental intermixing occurs between elements of the foil covering and the anode layer, wherein the resultant ions must migrate through the individual layers of the cathode composition for efficient electrical conductivity. Though the examples disclose the use of protective Li foil coverings to serve as an experimental sealant, preferred commercial embodiments of battery cell 200 would not contain a foil covering, owing to the desire to manufacture a thin film battery cell of minimum weight and enhanced specific capacity.

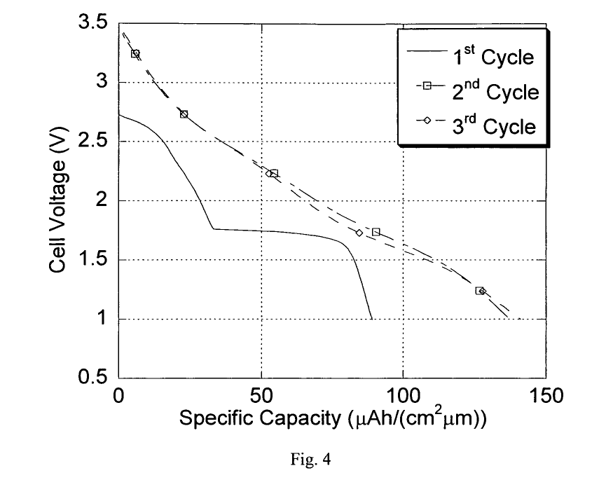

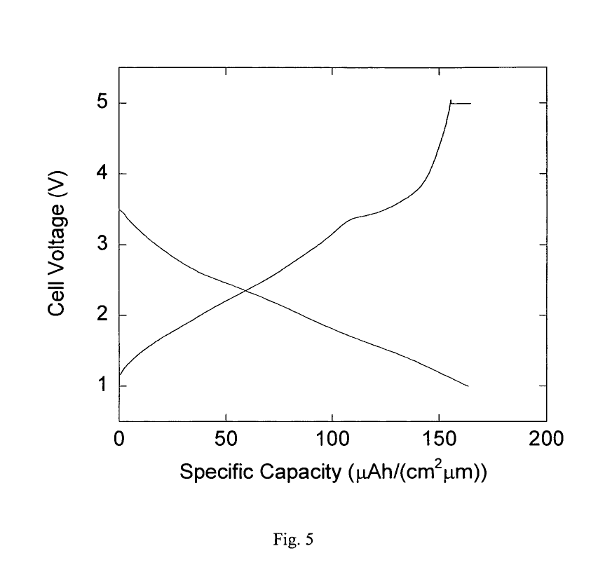

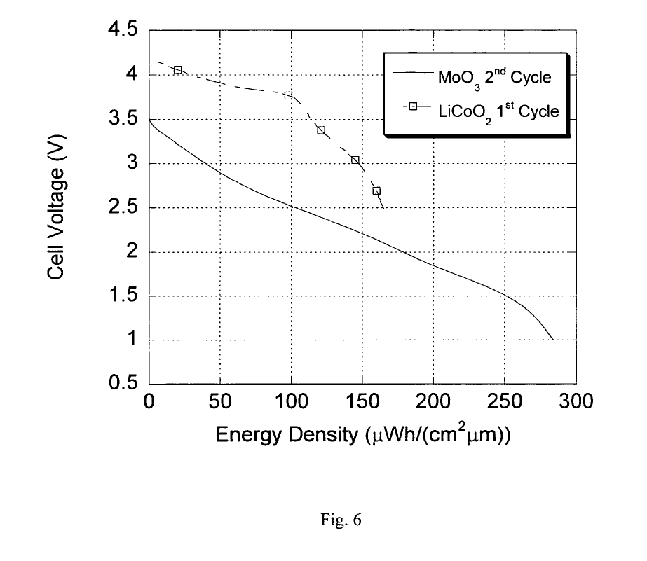

The first MoO₃ film cell discharge shows two distinct plateaus, yielding a specific capacity of about 90 μAh/(cm²-μm) (FIG. 4). On recharge and subsequent discharges, these plateaus disappear and become broad, smoothly sloping profiles with greater capacity of about 140 μAh/(cm²-μm). Assuming the films were fully densified MoO₃ at 4.69 g/cm³, this value corresponds to a specific capacity of 298 mAh/g, which falls between the theoretical capacity of α-MoO₃ (1.5 Li per molecule of MoO₃) at 279 mAh/g and β-MoO₃ at 370 mAh/g (2 Li per molecule MoO₃). This result is consistent with the XRD data indicating the presence of both α- and β-MoO₃. Typical charge/discharge curves for these cells are shown in FIG. 5. When tested at 150° C., the energy density of the MoO₃ cells significantly surpasses that of LiCoO₂ cells despite the lower operating voltage range of the MoO₃ cathodes (FIG. 6).

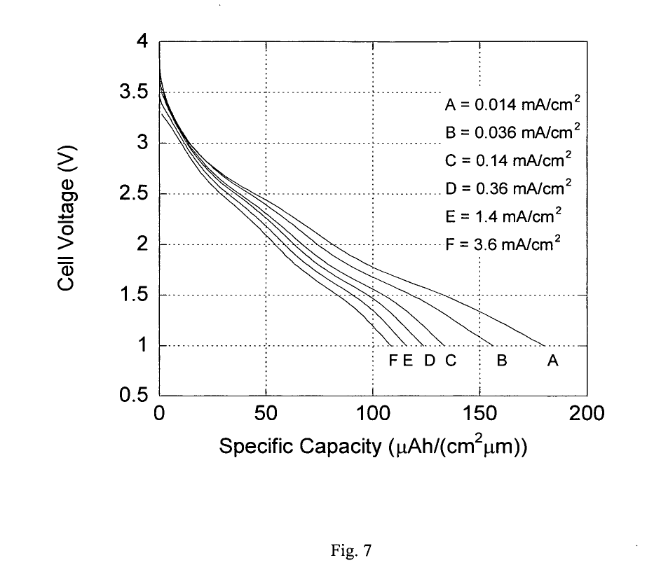

The rate capability of the MoO₃ cathodes was very good, as shown in FIG. 7. The cells retained about 60% of the low discharge rate capacity when discharged at 3.6 mA/cm². At very low discharge rates of 0.014 mA/cm², the specific capacity from 3.5V-1 V was 180 μAh/(cm²-μm). This would correspond to a composition of about Li_{2.06}MoO₃, not unexpected for the deep discharge cut-off of 1V.

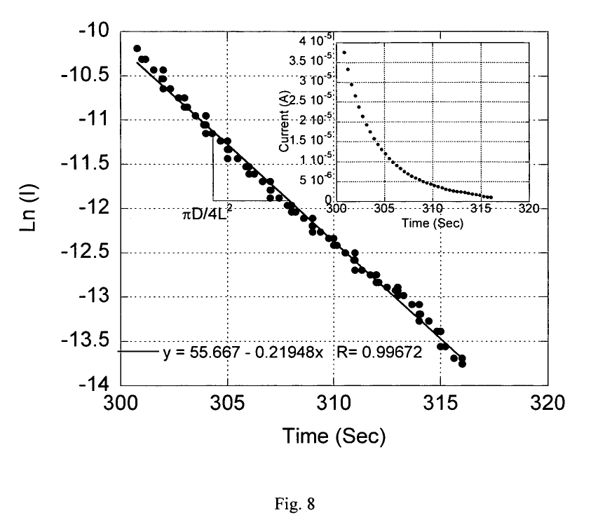

Potentiostatic Intermittent Titration Technique (PITT) measurements indicated the chemical diffusion coefficient of Li in MoO₃ was 7.5×10⁻¹¹ cm²/s at 153° C. at 2.24V for a 10 mV step size (FIG. 8). Since there were multiple phases present in the films, the diffusivity value represents an average value of all phases.

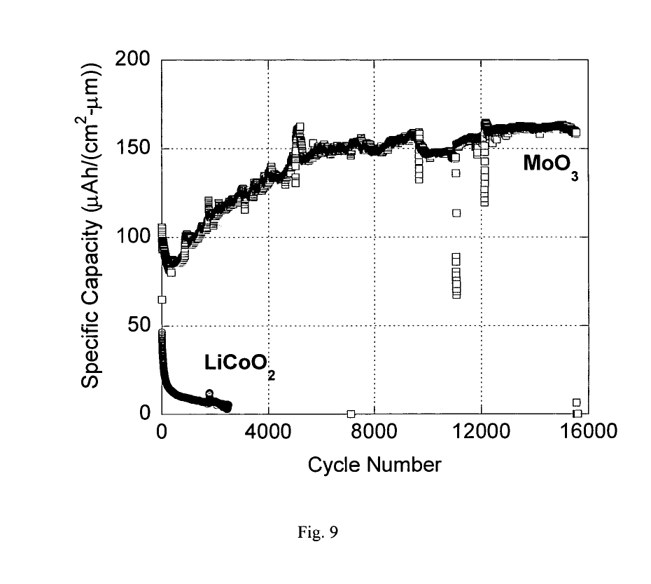

A dramatic quality of the MoO₃ thin film batteries is the cycle life at elevated temperatures. Whereas LiCoO₂ cells fade to about 50% of their initial capacity after only 100 cycles, the MoO₃ cells experience a slight capacity drop followed by recovery of the capacity, improving with increasing cycle number up to at least 5500 cycles, as shown in FIG. 9. After reaching a specific capacity plateau of about 160 μAh/(cm²-μm), the capacity of the cells does not change appreciably with cycling at least on the order of 10⁴ cycles. Within experimental error, the coulombic efficiency for each cycle was typically 100%. Some cells experienced steeper initial capacity fade and varying degrees of recovery of the initial capacity. Without being bound to any particular theory, these variations in performance may be attributed to differences in the MoO₃ film stoichiometry, which seems to be a function of preparation conditions, such as the specific location of the cell under the magnetron erosion ring. Some areas under the erosion ring produced the transparent-yellowish colored MoO₃, while other locations produced the purplish sub-stoichiometric MoO₃₋ₓ. No direct correlation of performance versus deposition location was observed since invariably all cells had visible color gradients across the cell. Nonetheless, most cells tested cycled without any apparent long-term capacity fade.

Sudden catastrophic failure, as opposed to gradual capacity degradation, was found to be the chief failure of the cells. Such failure was attributed to short-circuiting of the solid electrolyte as evidenced by a sudden drop in the cell resistance by several orders of magnitude to about 10 Ω. This electrolyte failure is not unusual for thin film batteries and is typically mitigated by using a thicker electrolyte film at the expense of greater cell resistance.

Cathode Thickness as an Important Design Consideration

An important design attribute of the cathode material compositions for both cathode performance in particular and battery cell performance in general is the role that cathode film layer thickness has upon battery cell integrity. The MoO₃ layers that form the cathode of the present invention will dilate (swell) during battery cell discharge, owing to the movement of Li⁺ ions into the MoO₃ layers. Should the cathode layer 205 formed inside battery cell 200 have a thickness that is not sufficiently small to accommodate the dilation of the MoO₃ layers, then the MoO₃ layers will expand and crack the solid electrolyte layer 206 that lies above the cathode layer 205. Consequently, the integrity of the cell will be preserved if a thin cathode layer 205 is used in battery cell 200. The preferred thickness of cathode layer 205 will of course depend upon the particular application of battery cell 200; however, a dimensional thickness of less than about 1 micron is preferred for the cathode layer.

### EXAMPLES

### Example 1

### Li Thin Film Battery Cell Fabrication

All solid-state Li thin film battery cells were fabricated on glass slides or Si₃N₄ coated Si substrates. The deposition of all the films (except the anode layer) was carried out in a planar RF magnetron sputtering chamber, evacuated to a base pressure of less than 5×10⁻⁶ Torr with a turbomolecular pumping system. The first layer consisted of a Ti adhesion layer and Pt current collector that was patterned through a shadow mask defining a 1.69 cm² square pad. Using the same shadow mask, the LiCoO₂ or MoO₃ layer was sputtered onto the cathode current collector, and then annealed in room air. The LiCoO₂ films were sputtered from a cold-pressed and sintered LiCoO₂ target as discussed by Neudecker et al. (2000), and annealed to 700° C. for one hour in air. The MoO₃ films were sputtered from a MoO₃ target (K. J. Lesker) and annealed for one hour in air. Next, the solid electrolyte film of Li_{3.3}PO_{3.8}N_{0.22} (LiPON) was deposited onto the cathode layer by sputtering a Li₃PO₄ target in N₂, following Yu et al. (1997). Finally, a Li metal anode layer was thermally evaporated onto the electrolyte through a second shadow mask defining an area of 0.7 cm² in the center of the cathode pad to complete the cell. In order to protect the cells during elevated temperature testing, the Li film was covered with Li foil cut to match the size of the Li pad, and then the entire cell was covered with Kapton tape. The deposition parameters for each layer for the MoO₃ based cells are shown in Table 1.

TABLE I
Preferredf nominal thin film cell deposition parameters.

| | Preferred | | | |
|---|---|---|---|---|
| | Nominal | | Deposition | |
| | Thickness | RF Power | Pressure | Sputter Gas |
| Layer | (μm) | Density (W/in²) | (mT) | Composition |
| Ti | 0.05 | 42 | 10 | 100% Ar |
| adhesion | | | | |
| Pt current | 0.3 | 42 | 10 | 100% Ar |
| collector | | | | |
| MoO₃ | 0.3 | 14 | 10 | 9% O₂, 91% |
| cathode | | | | Ar |
| LiPON | 3.0 | 14 | 15 | N₂ |
| electrolyte | | | | |
| Li anode | 5 | (thermally | — | — |
| | | evaporated) | | |

### Example 2

### Battery Cell Performance Attribute Measurements

Since the intent was to develop thin film batteries with a high tolerance to abusive conditions, deep charge and discharge cutoff voltages were employed, using moderately high current densities at a temperature well in excess of the targeted value of 120° C. To this end, the MoO₃ cells' charge cutoff voltage was 5V, the discharge cutoff voltage was 1V, and the cycling temperature was 150° C., at a (dis)charge current density of 0.7 mA/cm². A 60 second current taper step was employed on the charging. For the LiCoO₂ cells, the same conditions for cycling were employed with the exception that the charge cutoff voltage was 4.25V and the discharge cutoff voltage was 3V.

Film material was characterized using a Siemens D500 diffractometer run in the theta −2 theta geometry, with a Cu anode at an accelerating voltage of 40 kV and a tube current of 20 mA. Surface morphology was studied using a Hitachi field-emission scanning electron microscope (SEM).

The electrochemical characterization of the films was performed using a Princeton Applied Research 273A potentiostat, driven by Corrware Software (Scribner Associates). Cyclic voltammetry measurements were performed with sweep rates between 0.05-5 mV/s. The chemical diffusion coefficient was measured using potentiostatic intermittent titration technique (PITT) using a 10 mV step size. Cycling experiments were carried out using an Arbin battery cycler. All cells were charged and discharged in an Ar filled glove box. For elevated temperature testing, the cells were placed on a hot plate in the glove box with the temperature monitored using a thermocouple.

The results of these experiments are presented in FIGS. 4-9 and are discussed in the written description at paragraphs [054]-[057].

All printed publications, patents, and patent applications cited in this disclosure are hereby incorporated by reference herein in their entireties.

The foregoing description and drawings merely explain and illustrate the invention and the invention is not limited thereto. Those of the skill in the art who have the disclosure before them will be able to make modifications and variations therein without departing from the scope of the present invention.

1. A method of preparing a cathode electrode suitable for use in a thin film battery, comprising
a. applying an adhesion layer on a substrate;
b. forming a current collector layer on the adhesion layer; and
c. forming a layer of a Group 6 oxide composition on the current collector layer;
wherein the Group 6 oxide composition consists essentially of MoO₃ or WO₃.

2. The method of claim 1, further comprising applying a shadow mask on the current collector layer prior to applying the deposition layer.

3. The method of claim 1, wherein the adhesion layer is composed of a metal oxide composition.

4. The method of claim 1, wherein the current collector layer comprises Pt.

5. The method of claim 1, wherein the forming a layer comprises sputtering MoO₃ on the adhesion layer in a vacuum containing either argon or oxygen.

6. The method of claim 1, wherein the substrate comprises at least one member selected from the group consisting of a thin metal foil, a polyimide polymer, mica, glass, and Si₃N₄-coated Si.

7. The method of claim 3, wherein the metal oxide composition comprises a metal selected from the group consisting essentially of Co, Mo, and Ti.

8. The method of claim 5, wherein sputtering MoO₃ on the adhesion layer is achieved in an RF magnetron sputtering chamber fitted with an MoO₃ sputter target.

9. The method of claim 6, wherein the thin metal foil comprises a metal selected from the group consisting essentially of Ti, Au, and Al.

10. The method of claim 6, wherein the polyimide polymer comprises Kapton.

11. The method of claim 1, wherein the preparation of the cathode electrode comprises:
a. applying an adhesion layer comprising Ti on a substrate comprising Al;
b. forming a current collector layer comprising Pt on the adhesion layer; and
c. forming a layer of a metal oxide comprising MoO₃ on the current collector layer,
wherein the forming a layer is achieved by sputtering MoO₃ on the current collector layer using a MoO₃ sputter target in an RF magnetron sputter chamber.

12. A method of preparing a thin film battery cell, comprising
a. applying an adhesion layer on a substrate;
b. forming a current collector layer on the adhesion layer;
c. applying a first shadow mask of a first defined area on the current collector layer to provide a shadow masked current collector area;
d. forming a layer of a group 6 oxide on the shadow masked current collector area to provide a cathode electrode layer;
e. forming a solid electrolyte film layer comprising LiₐP_{b}O_{c}N_{d} on the cathode electrode layer;
f. applying a second shadow mask of a second defined area on the solid electrolyte film layer to provide a shadow masked solid electrolyte film layer;
g. forming a metal anode layer on the shadow masked solid electrolyte film layer to complete the thin film battery cell; and
h. sealing the thin film battery cell with a suitable sealant,
wherein a comprises a value from about 3 to about 3.3, b comprises a value of about 1, c comprises a value from about 3 to about 4, and d comprises a value from about 0.1 to about 0.3, and
wherein the second defined area is coincident with or a subset of the first defined area.

13. The method of claim 12, wherein the metal anode layer comprises Li.

14. The method of claim 12, wherein the adhesion layer is composed of a metal oxide composition.

15. The method of claim 12, wherein the current collector layer comprises Pt.

16. The method of claim 12, wherein the forming a layer comprises sputtering MoO₃ or WO₃ on the adhesion layer in a vacuum containing either argon or oxygen.

17. The method of claim 12, wherein the forming a layer is achieved in an RF magnetron sputtering chamber fitted with a sputtering target comprising MoO₃ or WO₃.

18. The method of claim 12, wherein the substrate comprises at least one member selected from the group consisting of a thin metal foil, a polyimide polymer, mica, glass, and Si₃N₄-coated Si.

19. The method of claim 12, wherein the group 6 oxide comprises at least one member selected from the group consisting essentially of MoOₙ or WOₙ, wherein n comprises a value from about 2.5 to about 3.3.

20. The method of claim 12, wherein the group 6 oxide comprises at least one member selected from the group consisting essentially of MoO₃ or WO₃.

21. The method of claim 12, wherein LiₐP_{b}O_{c}N_{d} is L_{3.3}PO_{3.8}N_{0.22}.

22. The method of claim 12, wherein the first define area and the second defined area comprises any shape and size.

23. The method of claim 12, wherein the forming of the metal anode layer is achieved by thermal evaporation.

24. The method of claim 14, wherein the metal oxide composition comprises a metal selected from the group consisting essentially of Co, Mo, and Ti.

25. The method of claim 18, wherein the thin metal foil comprises a metal selected from the group consisting essentially of Ti, Au, and Al.

26. The method of claim 18, wherein the polyimide polymer comprises Kapton.

27. A method of claim 12, comprising
a. applying an adhesion layer comprising Ti on a substrate comprising Al;
b. forming a current collector layer comprising Pt on the adhesion layer;
c. applying a first shadow mask of a first defined area on the current collector layer to provide a shadow masked current collector area;
d. forming a layer of a group 6 oxide on the shadow masked current collector area to provide a cathode electrode layer;
e. forming a solid electrolyte film layer comprising Li_{3.3}PO_{3.8}N_{0.22} on the cathode electrode layer;
f. applying a second shadow mask of a second defined area on the solid electrolyte film layer to provide a shadow masked solid electrolyte film layer;
g. forming a metal anode layer comprising Li on the shadow masked solid electrolyte film layer to complete the thin film battery cell; and
h. sealing the thin film battery cell with a suitable sealant.

28. The method of claim 27, wherein the group 6 oxide comprises at least one member selected from the group consisting essentially of MoO₃ or WO₃.

29. A cathode electrode suitable for use in a thin film battery cell, comprising
a. a substrate;
b. an adhesion layer applied on the substrate;
c. a current collector layer formed on the adhesion layer; and
d. a cathode layer comprising a group 6 metal oxide formed on the current collector layer,
wherein the cathode electrode displays a specific capacity in the range from about 190 mAh/g to about 300 mAh/g or a specific capacity from about 90 μAh/(cm²-μm) to about 140 μAh/(cm²-μm).

30. The cathode electrode of claim 29, wherein the group 6 metal oxide comprises MoO₃.

31. A thin film battery cell, comprising
a. a substrate;
b. an adhesion layer applied on the substrate;
c. a current collector layer formed on the adhesion layer;
d. a cathode layer comprising a group 6 metal oxide formed on the current collector layer;
e. a solid electrolyte film layer composed of Li_{3.3}PO_{3.8}N_{0.22} formed on the cathode layer;
f. a metal anode layer comprising Li deposed on the solid electrolyte layer to complete the thin film battery cell; and
g. a sealant,
wherein the thin film battery cell displays a performance attribute comprising at least one member selected from the group consisting of (1) a specific capacity from about 90 μAh/(cm²-μm) to about 160 μAh/(cm²-μm) and (2) a specific capacity that does not appreciably deteriorate with cycling of the thin film battery cell at a temperature of greater than about 100° C.

32. A thin film battery cell of claim 31, wherein the group 6 metal oxide comprises MoO₃.

33. A thin film battery cell of claim 31, wherein the thin film battery cell displays the performance attribute comprising a specific capacity that does not appreciably deteriorate with cycling of the thin film battery cell at a temperature in the range from about 100° C. to about 150° C.

34. A thin film battery cell of claim 31, wherein the thin film battery cell displays the performance attribute comprising a specific capacity that does not appreciably deteriorate with cycling of the thin film battery cell at a temperature of about 150° C.

35. A thin film battery cell of claim 31, wherein the thin film battery cell displays the performance attribute comprising a specific capacity that does not appreciably deteriorate with cycling for greater than about 500 cycles when the thin film battery cell is cycled at a temperature in the range greater than 100° C.

36. A thin film battery cell of claim 31, wherein the thin film battery cell displays the performance attribute comprising a specific capacity that does not appreciably deteriorate with cycling from about 5000 cycles to about 10,000 cycles when the thin film battery cell is cycled at a temperature greater than about 100° C.

37. A thin film battery cell of claim 31, wherein the thin film battery cell displays the performance attribute comprising a coulombic efficiency of about 100% for each cycle when the thin film battery cell is cycled at temperatures greater than 100° C.
